(19) United States
(12) Patent Application Publication
(10) Pub. No.: US 2018/0246992 A1
(43) Pub. Date: Aug. 30, 2018

(54) Multiple Time-Dimension Simulation Models and Lifecycle Dynamic Scoring System

(71) Applicant: Dynamic Simulation Systems Incorporated, New Castle, DE (US)

(72) Inventors: Ruizhi Bu, Clarendon Hills, IL (US); Yuanyuan Peng, New Canaan, CT (US)

(21) Appl. No.: 15/878,411

(22) Filed: Jan. 23, 2018

Related U.S. Application Data
(60) Provisional application No. 62/449,180, filed on Jan. 23, 2017.

(51) Int. Cl. G06F 17/30; G06F 17/50

(52) U.S. Cl. CPC G06F 17/30979; G06F 17/5009

(57) ABSTRACT

A lifecycle dynamic modeling system includes a user device that includes a controller, a database, and a memory within the wireless device and in communication with the controller. The memory includes program instructions executable by the controller that, when executed by the controller, cause the controller to receive data from the database, wherein the data includes a plurality of data points over a period of time, divide the data into a plurality of vintages based on time periods, divide each of the vintages in a plurality of vintages into a plurality of segmented-vintage cohorts based on one or more attributes of the data, and determine a score based on a modeling rate that varies over time, wherein the modeling rate is based on the plurality of segmented-vintage cohorts.

### CROSS-REFERENCE TO RELATED APPLICATIONS

This application incorporates by reference and claims the benefit of priority to U.S. Provisional Application No. 62/449,180, filed on Jan. 23, 2017.

### BACKGROUND OF THE INVENTION

The present subject matter relates generally to (1) an innovative statistical modeling approach designed to create Multiple Time-dimension Simulation Models and (2) the main applications of the new approach to generate Lifecycle Dynamic personal scores. More specifically, the subject matter relates to a system for building scoring models in the consumer finance industry that will allow businesses to assess both short-term and long-term risk and profit, calculate probabilities of default (PDs) at different levels of aggregation, and view scenario-based forecasting. The same approach can readily be used in personal insurance and customer-level retail marketing and consumer purchase behavioral analysis.

Personal credit scoring is predominantly based on the approach originally established by FICO. Scores built with this approach serve as a basis for general decision-making methods in all areas of consumer loan origination and account management processes. Further, more recently the scoring system has been applied to regulatory stress testing and submissions.

Despite the widespread applications of this traditional credit scoring and the importance placed on these scores, the current approach is based on ideas, data structure, algorithms and computational architecture built in the 1980s. As such, it presents a number of drawbacks that are inconsistent with modern technology and approaches. First, only limited data is used, which contrasts with the big data capabilities of modern times. Scores are generated one kind at a time even though multiple kinds could be generated at the same time. Further, scores are built with limited applicable time horizons, while present technology permits flexible time horizons, including one month out to the lifetime of the loans. Finally, scores are built with limited purposes and are used in isolation of the other purposes they may fulfill.

Accordingly, there is a need for a system of scoring that consolidates corporate modeling efforts, brings new functionalities into the scores and broadens the power of scoring, as described herein.

### BRIEF SUMMARY OF THE INVENTION

To meet the needs described above and others, the present disclosure provides a system of scoring that consolidates corporate modeling efforts, brings new functionalities into the scores and broadens the power of scoring. The present disclosure addresses situations in which the disclosed system may be used to replace leading analytical and forecasting models in consumer lending. However, those skilled in the art will recognize additional applications for the systems and methods described herein.

By providing a consolidation of the various modeling approaches in the lending business, the system described herein addresses multiple needs and functions while also providing time-variable results. The system is built on a new mathematical approach to creating scoring models with a vintage-based data structure based on large-data formation. The system also introduces economic and other environmental impacts in credit scoring. The elements of the system include a theoretical formulation, a data structure, a segmentation scheme and multiple time-dimension decomposition technology. The system may be implemented through a modeling software platform that allows the user to build scoring models, and a production platform that allows the user to produce scores for each customer or account on monthly or quarterly basis.

The system contemplates a system administrator for modeling that generates scores according to pre-determined frequency (for example, monthly) and sends scores to receivers in other departments that have some utility for the scores. These departments may include portfolio management for product upsell and cross-sell, delinquency and loss forecasts; collections, to collect overdue payments; finance, for revenue, expense and profit forecasts; capital reserve, for regulatory capital reserve calculations; and comprehensive capital analysis and review (CCAR) or Dodd-Frank Act Stress Tests (DFAST) for loss and income stress testing. In departments, baseline scores will be used for short-term business forecasts and long-term business planning, while stressed scores will be used for regulatory stress testing and capital planning.

Score building may use all historical data up to the most recent month. Score values may represent actual performance rate (PD or any other rate per design) for the modeled portfolio.

An advantage of the invention is that it provides time-variable results.

Another advantage of the invention is that it consolidates modeling methods.

Yet another advantage of the invention is that it introduces economic environmental impact in credit scoring.

A further advantage of the invention is that it may consider all historical data up to the most recent month.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a schematic of the lifecycle dynamic modeling system of the present application.

FIG. 2 is a comparison of the cumulative calculation of probability of default (PD) as compared to the traditional fixed forecast PD scores.

FIG. 3 is a graph illustrating the lifecycle dynamic scoring under various, dynamic environmental settings.

FIG. 4 is a graph illustrating potential applications of the lifecycle dynamic modeling system of the present application.

FIG. 5 is a graph illustrating lifecycle progressions of successive vintages of the lifecycle dynamic scoring system of the present application.

FIGS. 6 and 7 illustrate the lifecycle patterns and migrations of successive vintages of the lifecycle dynamic scoring system of the present application.

FIG. 8 is a graph illustrating the lifecycle dynamic modeling in example consumer loan applications.

FIG. 9 is a graph illustrating the historical disaster occurrence and simulation of future occurrences based on the lifecycle dynamic modeling system of the present application.

FIGS. 10 and 11 illustrate the impact of new product introduction and the impact of seasonality, respectively, on online retail, according to the lifecycle dynamic modeling system.

FIG. 12 is a graph illustrating a life-story of a vintage as modeled by the lifecycle dynamic modeling system.

FIG. 13 is a chart illustrating a comparison between the traditional scoring model data and the data of the lifecycle dynamic modeling system.

### DETAILED DESCRIPTION OF THE INVENTION

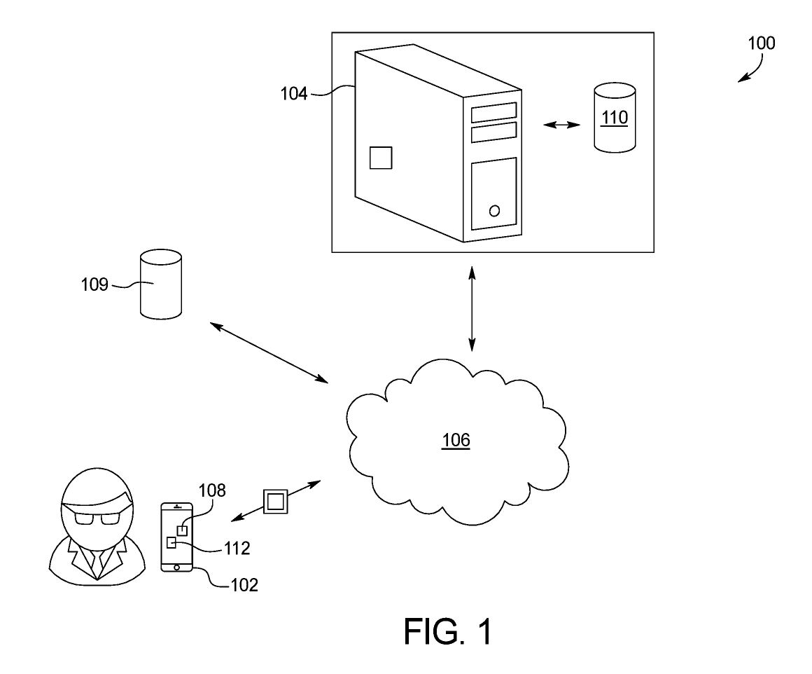

The present disclosure provides a lifecycle dynamic modeling system 100 of scoring that consolidates corporate modeling efforts, brings new functionalities into the scores and broadens the power of scoring. Referring to FIG. 1, the lifecycle dynamic modeling system 100 generally includes a theoretical formulation, a data structure, a segmentation scheme, and multiple time-dimension decomposition technology. In one example, the lifecycle dynamic modeling system 100 includes a user device 102 in communication with a server 104 through a network 106. Wired or wireless communication links may relay communication between the devices 102, 104 across the network 106. The user device 102 includes a controller 108 that accesses data from the server 104, a database 109, or a database 110 in communication with the server 104. The user device 102 also includes memory 112 in communication with the controller 108, the memory 112 including instructions that, when executed by the controller 108, cause the controller 108 to carry out the lifecycle dynamic modeling as described herein.

In some embodiments, the system is implemented through a modeling software platform that allows the user to build scoring models and a production platform that allows the user to produce scores for each customer or account on monthly or quarterly basis. The user device may be a computer, a smart phone, a tablet, or any other suitable device.

For reference, the following sections proceed with probability of default (PD) scores as an example to illustrate the basic features underlying the system and to illustrate how this system differs from traditional scoring models such as FICO scores. The model described herein may be used to model other scores such as EAD, LGD and profits.

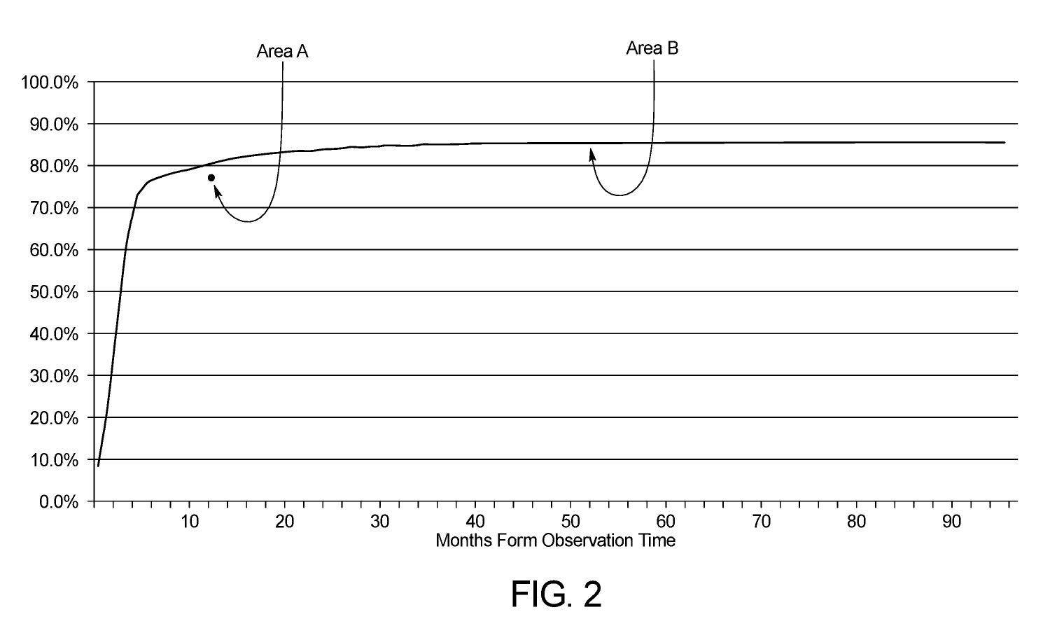

FIG. 2 compares the lifecycle PD calculation with the traditional fixed forecast time horizon. Traditional PD scores predict the probability of default in a fixed future time-period, such as 12 or 18 months for origination scores or shorter performance windows for behavioral scores. For example, PD in a 12-month fixed window after the observation month is a point forecast such as the point shown in Area A. In this case, the development population is typically different from the scoring population such that the forecast PD does not correspond to the true PD. In contrast, the lifecycle dynamic modeling system 100 described herein forecasts cumulative PDs for the lifecycle of the loan shown in Area B. Dynamic scoring uses the actual portfolio data through the most recently available data set.

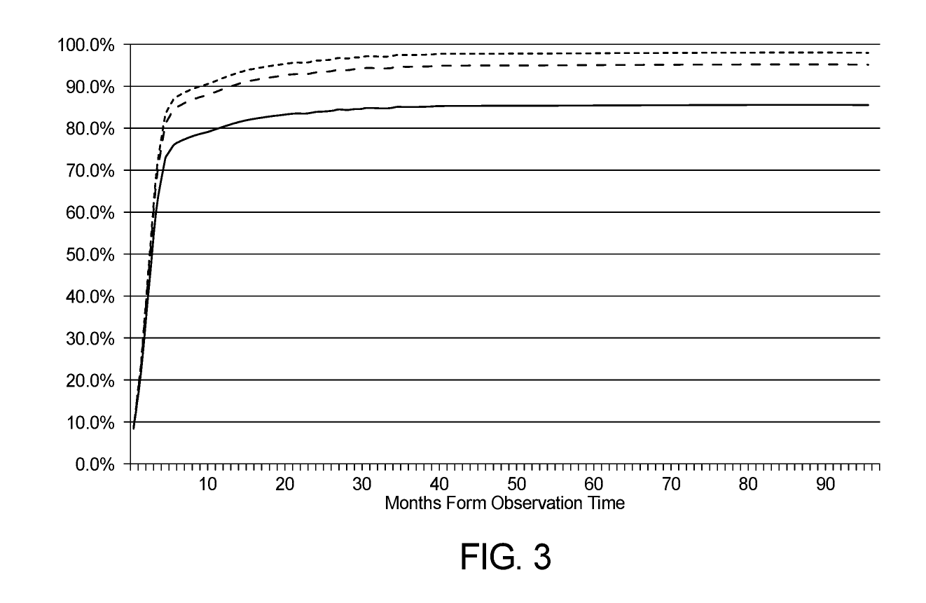

FIG. 3 illustrates the lifecycle dynamic scoring under various, dynamic environmental settings. Within the same account, lifecycle PD scores will be different under different economic and/or policy assumptions. For the same account, the lifecycle dynamic modeling system 100 provides a different path for each set of economic and/or policy assumption. In FIG. 3, the solid line illustrates a lifecycle cumulative PD curve under an optimistic economy. The long dash line and the short dash line illustrate a lifecycle cumulative PD curve under the baseline and stressed economic scenarios, respectively.

Traditional scores are ranking scores. In contrast, the system described herein measures the true cumulative PD values for the exact score population. This means that the score can be directly used to calculate the number of defaults at different levels of aggregations: from account level to segment, portfolio, institution and industry levels to measure overall default risk or serve a risk index.

The scoring system described herein assigns scores to each account. Since the score values are true probabilities, account-level PDs can be aggregated up to segment, product, portfolio, institutional, and industry levels. For example, Table 1 below displays how account-level cumulative PDs are aggregated to the portfolio level at a representative age-point. The same equation can be applied to any age-points in the lifecycle. With respect to the notations in Table 1, assume K cohorts in the portfolio, Sᵢ is the score for all the accounts in cohort i, and Nᵢ is the number of accounts in the same cohort.

TABLE 1
Aggregations to the portfolio level at different age-point - default
accounts and cumulative PD rate

| LCD Scores at Different Age- | Calculations of Default Accounts and |
|---|---|
| points | PD Aggregations |
| S^{12m} - Account level score at | Default Accounts: |
| 12 month-since-observation | (Total number of default accounts)^{12m} = |
| For 12-month default accounts | Σ₁^{K} Nᵢ * Sᵢ^{12m} |
| and cumulative PD rate | Cumulative PD Rate: |
| calculations | (Cumulative PD Rate)^{12m} = |
| | $\frac{( {\sum }_{1}^{K} {N}_{i} * {S}_{i}^{12 m} )}{{\sum }_{1}^{K} {N}_{i}}$ |

Further aggregations may be performed in successions from portfolio to institution and to industry levels. Table 2 below displays the aggregation formulas as an example of a three-level progressive aggregation process, assuming that there is a total of L portfolios for an arbitrary institution and M institutions in the industry.

TABLE 2
Aggregations to higher levels

| Levels of Aggregations | Aggregation Formula |
|---|---|
| 1. Portfolios to Institution - Company Risk Indicator Assuming L portfolios (P₁, P₂, . . . Pₗ) in an institution | ${( S )}^{Ins} = \frac{( {\sum }_{l = 1}^{L} {N}_{l} * {S}_{l}^{Part} )}{{\sum }_{l = 1}^{L} {N}_{l}}$ |
| | Where: (S)^{Ins} is the institutional |
| | level PD score; Nₗ and Sₗ^{Part} are |
| | the number of accounts and the |
| | portfolio level PD score in |
| | portfolio l respectively. |
| 2. Institution to Industry - Industry Risk Indicator Assuming M institutions (I₁, I₂, . . . Iₘ) in the industry | ${( S )}^{Ind} = \frac{( {\sum }_{m = 1}^{M} {N}_{m} * {S}_{m}^{Ins} )}{{\sum }_{m = 1}^{M} {N}_{m}}$ |
| | Where: (S)^{Ind} is the industry |
| | level PD score; Nₘ and Sₘ^{Ins} |
| | are the number of accounts and |
| | the portfolio level PD score in |
| | portfolio m respectively. |

Under the system described herein, the scores may be centrally produced and then distributed to end-user groups. End-users may use a program in SAS or R software suites to create the account level scoring and aggregations described herein.

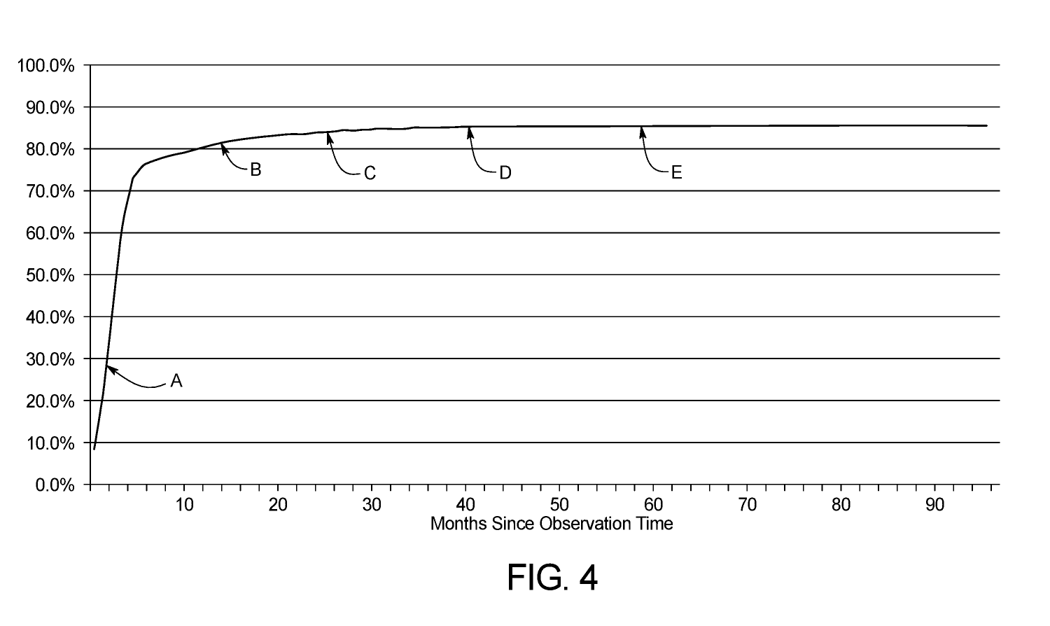

The potential applications of the system described herein include a variety of areas as shown in FIG. 4. One example is the Satisfying Current Expected Credit Losses (CECL) requirements. This utility relates to a new financial reporting mandate by the US Financial Account Board requiring all institutions holding loan and leasing portfolios to report expected losses based on lifecycle of the loans under different future economic and policy conditions. Another example is the IFRS 9 requirements, which is the European equivalent of CECL, also applicable to Canadian institutions. Additional examples are the Comprehensive Capital Analysis and Review (CCAR) exercise and the Dodd Frank Annual Stress Test (DFAST). The scores generated by the lifecycle dynamic modeling system may be used as a challenger/confirming model for all products in CCAR and DFAST regulatory submissions, providing ease and uniformity.

Additional applications include business long-term strategic planning and portfolio management. Lifecycle and environmental-based scores are a preferred approach for long-term strategic planning and benchmarking. Regarding portfolio management, this scoring approach, when combined with an effective segmentation scheme, can provide accurate short-term behavior separation in PD and other performance measures, providing an alternative to traditional behavioral scores.

Referring to FIG. 4, each of Areas A-E correspond to lifecycle check-in points that are particularly useful in certain applications. Area A highlights the six-month check-in point that is often referred to in portfolio management. Area B is the 12-month check-in point for annual planning and IFRS 9. Area C is the 27-month check-in point useful in the CCAR and DFAST models. Areas D and E are the 3-year and 5-year (and subsequent lifecycle) check-in points for strategic planning, CECL, and IFRS 9.

From a much broader perspective, the lifecycle dynamic model 100 can be applied to any process that (i) has a constant stream of lifecycle progressions, and (ii) is subjected to impacts of time related factors.

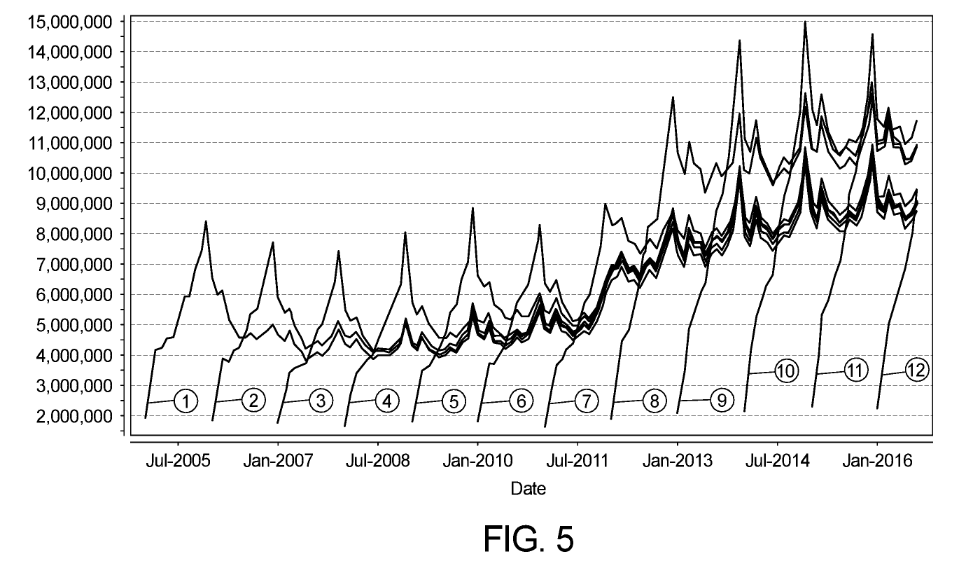

FIG. 5 shows lifecycle progressions of successive vintages. Each of curves 1-12 represents the lifecycle progression of one vintage over time. As illustrated in the figure, there is a common lifecycle pattern for all vintages. Further, all vintages 1-12 regardless of age are subject to time impacts, such as long-term upward trend, interruptions, and seasonal fluctuations.

Most social and economic processes share the above features. For example, age-related items of consumption include consumer goods such as types of food, clothing, transportation, education, and healthcare. Regardless of age, the above items are impacted by time-related factors including: changes to technology such as the introduction of the smart phone and the internet, changes in public opinions and perceptions, changes in legislations and regulations such as the legalization of drugs, and seasonality. Almost all the things around us have lifecycles, and almost none of them are time-impact free. In this era of big data, lifecycle data is increasingly available for more things than we could ever imagine. For example, lifecycle data related to a user's viewing pattern based on Netflix usage is available, including viewing frequency, duration, time of day, and content categories.

The three main reasons that trigger the need for lifecycle analysis are (i) understanding the lifecycle pattern by knowing what to anticipate from the start for better planning; (ii) understanding lifecycle differences by knowing what to choose or how to adapt; and (iii) understanding lifecycle migrations by knowing the dynamics of lifecycle behavioral changes. One of the advantages of the lifecycle dynamic modeling system 100 is the ability to separate out time impacts from the lifecycle process and the quantification of different time-impact factors.

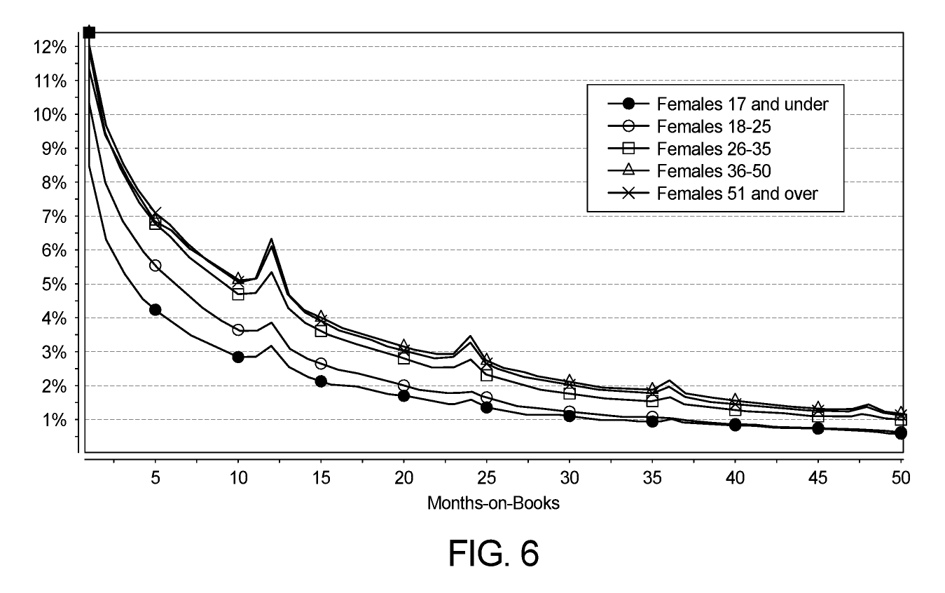

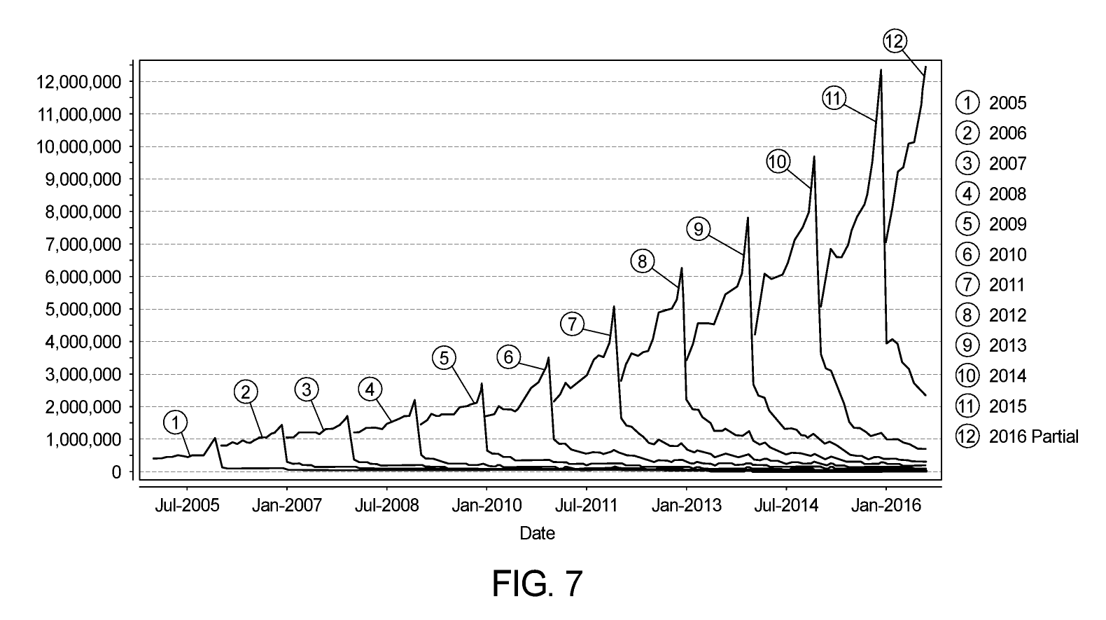

FIGS. 6 and 7 illustrate the lifecycle patterns and migrations of successive vintages. Referring to FIG. 6, the rate of the lifecycle pattern declines over the age line and jumps at anniversaries. With respect to FIG. 7, the lifecycle pattern evolves over time.

The three major categories of time related impacts are as follows. Understanding and quantification of the above impacts are necessary for better decision-making in planning, preparation and prevention.
1) Long-term trends and cyclical/seasonal impacts:
   Chronological and cyclical impacts—for example, impacts of smog level increases on death rates of the old and the young; seasonal flues.
2) Obstructions
   Economic crises and natural disasters interrupt natural vintage progressions—for example insurance payouts and loan default rates
3) Interventions
   Measures taken to change the future course for intended outcomes

The main purpose of lifecycle dynamic scoring is to distribute model results. Transportability has two dimensions: (i) from model generation process to result applications processes; and (ii) from the development population to different application populations. With respect to the first aspect, organizations commonly have centralized modeling functions to produce forecast results intended for use by different business departments. When modeled results are in the form of scores at the account level, different departments can use them in the most flexible way. A typical example of the second aspect is the generation and use of the credit bureau scores. Bureau scores are generated with national data at the credit bureaus, and the applications are often at the banks.

Lifecycle Dynamic Modeling requires two things that smaller operations may not have at the same time: (i) big data, and (ii) resources such as financial investments and user expertise. As a result, third-party vendors, such as credit bureaus or other specialty data companies, can determine the scores and deliver them to user companies. Lifecycle scores are no different from existing bureau scores in terms of centralized generation and electronic distribution to end users.

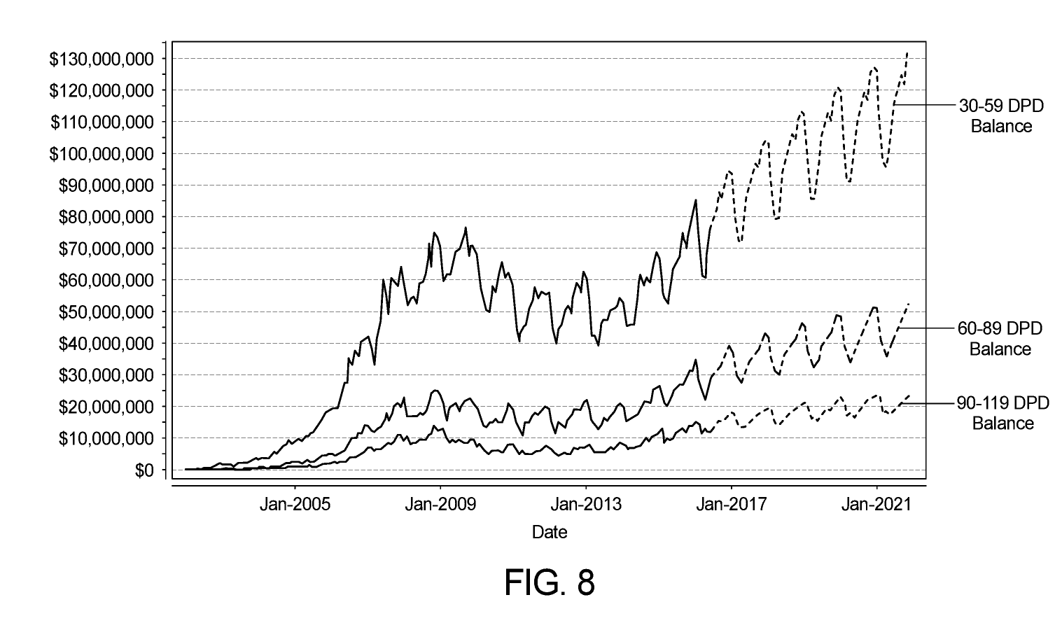

The top three commercial opportunities for lifecycle dynamic simulation models are in consumer lending, insurance, and online retail. Applications in consumer lending include (1) consumer loans such as credit cards, auto loans, mortgages, home equity lines of credit, and secured and unsecured installment loans, (2) simulated risk variables such as fraud, default, and losses and recoveries, and (3) simulated finance variables such as income flows, expenses, and profits. FIG. 8 illustrates the lifecycle dynamic modeling in example consumer loan applications for various Days Past Due (DPD) ranges. The solid portion of each curve represents historical data and the dashed portion of each curve represents forecasted data. Other typical examples are incomes such as interest income, financial charges, exchange fees; expenses; purchases and payments.

The outcomes of these models can be used by different functional teams within a lending institution, and/or to satisfy various regulatory requirements. For example, within a lending institution, the areas of business applications within consumer lending including risk and financial management, such as portfolio management, long-term planning, strategic planning, and industry benchmarking, and regulatory compliance, such as loss stress testing (CCAR and DFAST) and financial reporting (CECL-US, IFRS 9, etc.).

The insurance businesses fall into two main categories: accidental and disaster. For accidental insurance, the modeling is the same as default modeling in consumer lending with variables specific to the insured incidents. Modeling probability and severity of the accident occurrences for auto, homes, personal property, and health. For disaster insurance, the key strength of the lifecycle dynamic modeling system 100 is the capability to simulate the impacts of disasters, such as earthquake, tsunami, and hurricane events.

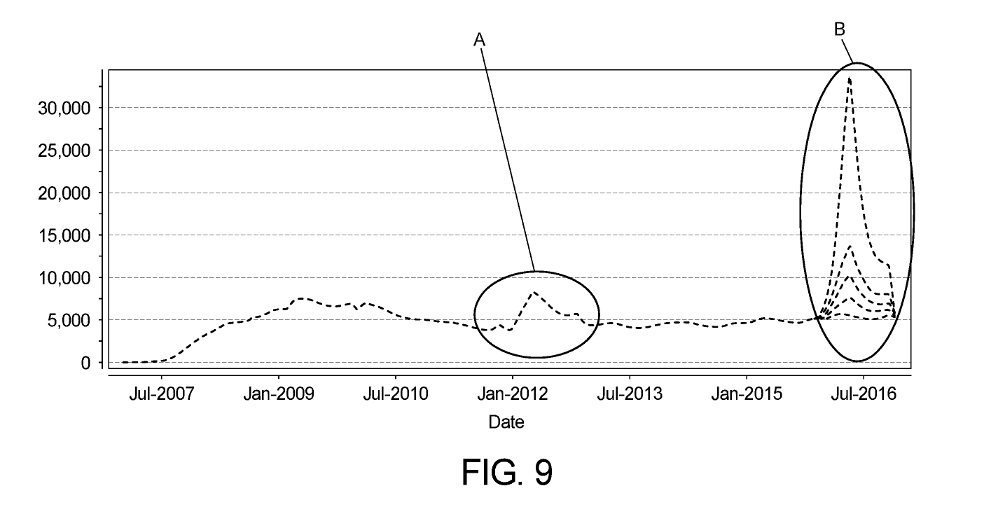

FIG. 9 illustrates the historical disaster occurrence and simulation of future occurrences. At Area A of the curve, disaster occurred in 2012, which caused delinquent accounts to jump. Over time, this jump partially recovered. The pattern and magnitudes of the impact of the 2012 disaster on defaults was modeled using LookAhead® Scenario-based Forecasting Software. The same impact-response pattern was applied to the future period in 2016 at Area B of the curve with five magnitude assumptions: no peril (benchmark), 50%, 100%, 150%, and 300% of the historical magnitudes.

Large online retail stores have two types of main businesses: merchandize and payment facilities. These operations face fierce competitions and have big data in hand, making them the most likely candidates for high-end model adoptions Online retail businesses focus on customer signups and retentions, and product and service penetrations into these customer bases. Accordingly, online retail businesses are primarily concerned about new customer signups each month (vintage creations), the number of active users after signup, transaction frequency and average purchases, and Income, expenses and profit flows. In order to fend off competitions, retailers actively conduct campaigns and promotions.

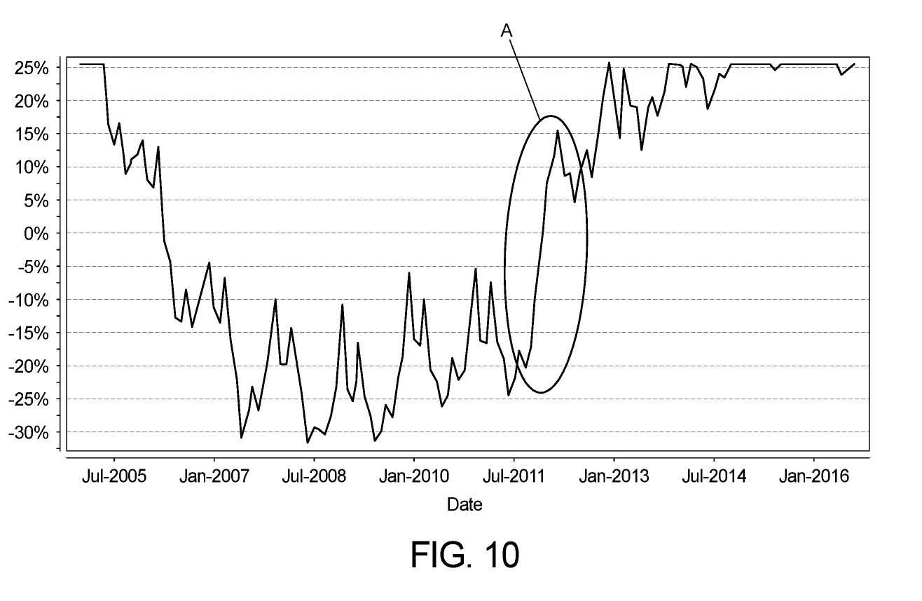

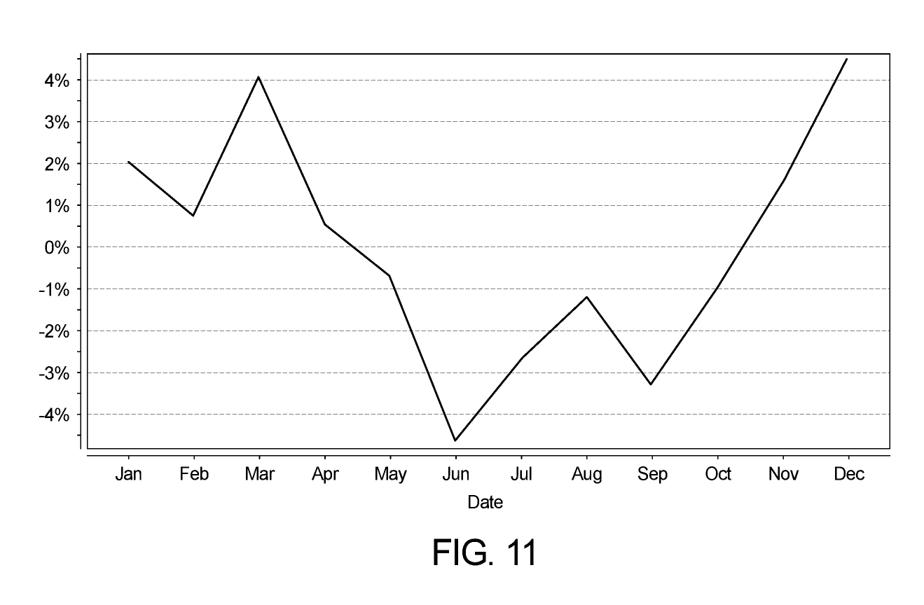

The lifecycle dynamic modeling system 100 can help online retailers understand the impacts of campaigns, promotions, introductions of new product and services on new customer signups, customer retention rate, and transaction frequency and average spends. It can also help online retailers understand how external factors such as competition, consumer perceptions of online purchases, and seasonality, impact the matrices of concern. FIGS. 10 and 11 illustrate the impact of new product introduction and the impact of seasonality, respectively, on online retail. More specifically, the jump in the curve at Area A in FIG. 10 corresponds to the introduction of a new product. Table 3 below provides details related to the impact of the introduction of Bitcoin payment as an example.

TABLE 3
Impact of the Introduction of Bitcoin Payment
“Among all the factors, the contribution of Bitcoin introduction is 0.49%”

| | Net impacts | | | |
|---|---|---|---|---|
| | of Vintage | | | |
| | Aging and | | | |
| | Statistical | From Existing Vinatge | | From Environment |
| 2014-08 Actual | Noise | Aging | From New Activations | Trending + noise |
| $123,170,201 | $(144,961) | $123,025,240 | $1,735,654 | $2,615,052.04 |
| | −0.12% | 100.25% | 1.41% | 2.13% |

| | | 2014-09 | | |
|---|---|---|---|---|
| From Sept. | From 2014-09 | Simulated | | 2014-09 |
| Seasonality | Bitcoin Event | Number | Unexplained | Actual |
| $(4,263,086) | $805,263 | $123,718,114 | −1,000,0681 | 122,717,433 |
| −3.47% | 0.49% | 100.6% | −0.8% | 100% |

### Data Structure for Lifecycle Dynamic Modeling and Scoring

In the lifecycle dynamic modeling system 100, all accounts are bundled in cohorts defined as the cross-sections of vintage and segment. There are two types of vintages: origination vintage and snapshot vintage. An origination vintage consists of all accounts originated within the same month or quarter. A snapshot vintage consists of all accounts on the book in a month or quarter, regardless of their respective time of origination. For both of these vintage cohorts, historical performances can be tracked and future performances are simulated. In the system described herein, the two definitions can be used in conjunction, one for new originations and the other for existing accounts. Regarding segments, loans with different characteristics generate different income, expense, and loss paths with either vintage definition. For origination vintages, segmentation is based on loan characteristics at time of origination. With snapshot vintages, segmentation is based on loan characteristics at time of observation. This way, up-to-date information is used to the fullest extent for all accounts.

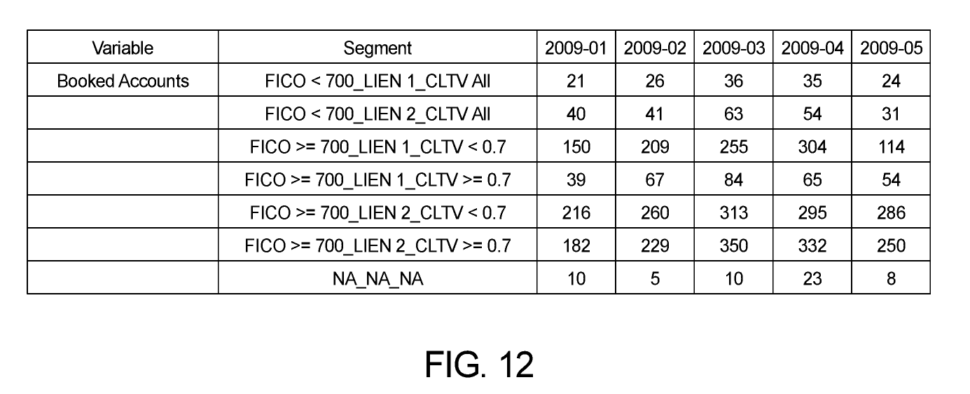

Lifecycle modeling simulates vintage performances by segment, which means that a segmented-vintage is the smallest cohort for which performances can be tracked and simulated. FIG. 12 shows the division of performances into cohorts. Each column 2009-01-2009-05 shows a monthly vintage. Each row is a segment. Each number in the chart is the segmented-vintage.

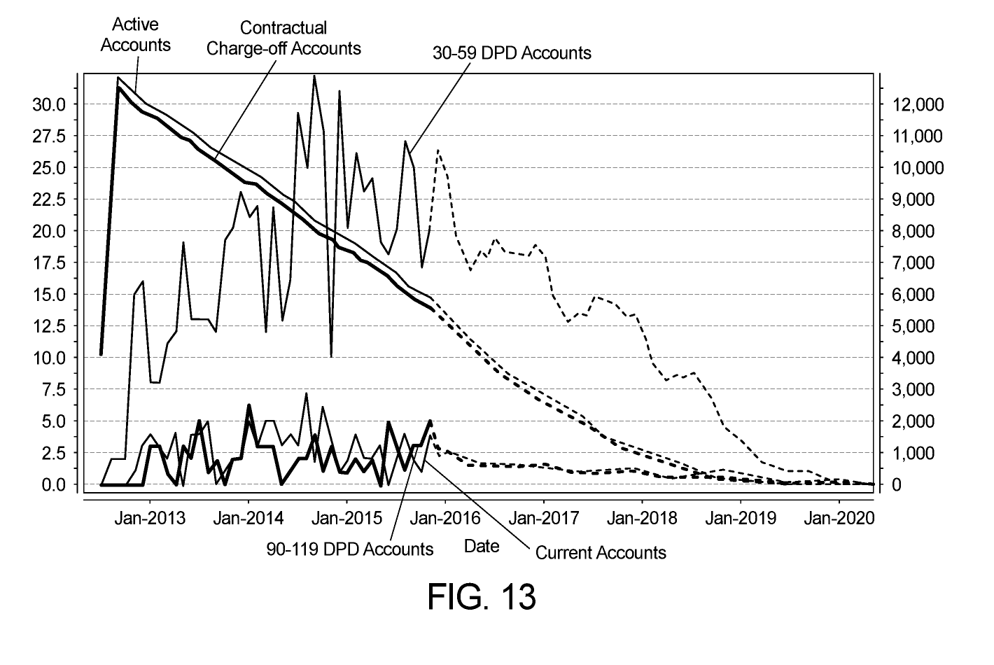

A vintage's life starts from the month of observation, after which the vintage generates performances as it ages. Performances may be conventionally classified into risk variables, finance variables, collections, recoveries, and other suitable classifications. FIG. 13 displays a portion of a life-story of the 2012-Q3 vintage (aggregated from monthly vintages) through January 2016. The segment is defined by over 760 FICO-band and term (7-year) for an auto product. This graph displays risk variables on the account side. Performance variables are commonly classified into risk and finance categories and are often tracked in tandem.

### Data Structure

The lifecycle dynamic modeling system 100 described herein relies on a data structure that is more sophisticated than the data structure for traditional scoring. With respect to observation data, which records the total number of accounts whose performances are to be tracked in the subsequent performance period, traditional scoring models use a certain short period (observation window) of historical data. This section is typically a few years back in the recent past. By contrast, the scoring system described herein uses all historical data, going back as far as desired and as new as available.

Performance data measures how many accounts recorded in the observation window turned out to be bad (in this PD example) in the performance window. Traditional scoring models use a short section of historical performance data after the month of observation. The lifecycle dynamic scoring system 100 described herein uses all available historical performance data after time of observation.

### Segmentation Scheme

For concept illustration purposes, the following section uses a hypothetical two-characteristic (X1 and X2) example to demonstrate the principle of segmentation in the scoring system described herein. Those skilled in the art will understand this hypothetical in the context of the logistic regression scoring approach.

With logistic regression, we assume that X/ has M number of attributes and X2 has N number of attributes. This results in a total of M*N=K unique account cohorts. For each of the account cohorts, odds (which are later translated to PD) are calculated. These K number of log-odds and (X1, X2) combinations are used as sample points to parameterize E (5.1). Accounts in the same cohorts will have the same scores. With FICO, there are about 250 effective scores for the entire population after raw-score scaling and rounding.

With the system described herein, the same K unique cohorts are used for segmentation. For each of the K cohort, or segment, the monthly performances are tracked after the observation point. This process is based on big data, which is what makes lifecycle modeling possible.

The following chart illustrations the conceptual differences between the system and the logistic regression approach. In this example, there are two characteristics, and a total of 35 segments are created. A real-world example is also partially displayed, in which 4 characteristics generated 250 cohorts (segments).

TABLE 5.1
Comparison of segmentation schemes
Segmentation Schemes Cross-referenced

| Lifecycle Dynamic Scoring | Logistic Regression |
|---|---|
| Segmentation Scheme: M*N = 5*7 = 35 segments $K = ( \begin{matrix}( current , \text{<} 50 ) ; ( current , 50 \text{-} 74 ) ; & ⋯ & ( current , \text{>} 95 ) \\ ( x \text{-} 29 , \text{<} 50 ; ( x \text{-} 29 , 50 \text{-} 75 ) ; & ⋯ & ( x \text{-} 29 , \text{>} 95 ) \\ ⋯ & ⋯ & ⋯\end{matrix} )$ The vintage data structure as described in Section 4 will be | For exhibition purposes, take a two-variable model: Ln(Odds) = c + a * X₁+ b * X₂ + ϵ E(5.1) Where characteristic X1 has M (number of) attributes and X2 has N (number of) attributes, i.e.: X₁ = (X₁₁, X₁₂, X₁ᵢ, . . . , X₁ₘ), and |
| pushed through the modeling process as mathematically | X₂ = (X₂₁, X₂₂, X₂ᵢ, . . . , x₂ₙ) |
| specified in Section 6 to generate lifecycle and time | In this case there will be M * N = K number of |
| dynamic components. These factors are overlaid in the | cohorts, and the same number of calculated |
| forecast period to generate lifecycle dynamic scores. The | Odds and row-scores. The following are real- |
| final result will be 35 lifecycle cumulative PD curves (in this | world examples of X1 and X2: |
| example) instead of 35 single-point PD forecasts generated | DelStatus = |
| with the traditional approach. | (current, x-29, 30-59, 60-89, 90-119, 120-149, 150- |
| | Utilization = (<50, 50-74, 75-89, 90-95, >95) |
| | K = M*N = 7*5 = 35 cohorts |

Segmentation Schemes For Origination and Snapshot Vintages

Origination Vintage

Recommended Segmentation Dimensions - Origination Vintages

| | Credit | | | | |
|---|---|---|---|---|---|
| | Cards | Auto | HELOC | HELOAN | Mortgage |
| Product or sub-product type | Yes | Yes | Yes | Yes | Yes |
| BT v. Non-BT | Yes | | Yes | | |
| Channel | Yes | Yes | | | Yes |
| Risk-bands | Yes | Yes | Yes | Yes | Yes |
| Fee v. No-fee | Yes | | | | |
| New v. Old | | Yes | | | |
| Purchase v. Leasing | | Yes | | | |
| Term | | Yes | Yes | Yes | Yes |
| Origination LTV (front end; back-end) | | Yes | Yes | Yes | Yes |
| Lien Position | | | Yes | Yes | Yes |
| Region Clusters | | Yes | Yes | Yes | Yes |

Snapshot Vintage - industry tested dimensions
Delinquency Status: X1 = (Current, x-29 DPD, 30-59 DPD, . . . , 120-149 DPD)
Utilization-bands: X2 = (<50%, 50%-90%, 90%-95%, ≥95%)
MOB-bands: X3 = (0, 1-6, 7-12, 13-24, >24)
Payment Pattern - dramatically enhance separations for accounts in current and low-delinquency buckets

### Mathematics of Lifecycle Dynamic Modeling and Scoring

### The General Equation

This section is to illustrate the process to deriving the fundamental framework; this framework will be transformed under different model design considerations. The starting point is equation E(1) under the constraint in E(2).

Rᵥₗ( [symbol] )=βᵥᵢ*(LC( [symbol] ))*TRᵥᵢ(t) E(1)

aᵥᵢ32 t−otᵥᵢ E(2)

In E(1), for any vintage, vi, the modeled rate, Rᵥᵢ(otᵥᵢ, t), varies as time, t, changes after the month of origination (or observation), otᵥᵢ. This rate is expressed as the multiplication of three components as detailed hereunder.

LC(A) is the lifecycle function, which is a function of age, A. The age for any individual vintage is denoted by aᵥᵢ.

As shown in E(1), the age of a vintage is the time difference between calendar time t and the month of origination (or observation) otᵥᵢ. This results in the identity equation in E(2): aᵥᵢ=t−otᵥᵢ. LC(A=aᵥᵢ) is the value of the lifecycle function when the common age A is set to age aᵥᵢ. Alternately, it is the value of the lifecycle function for vintage vi.

βᵥᵢ is the level scalar for vintage vi, representing the level different between the vintage specific rate curve Rᵥᵢ(otᵥᵢ, t) and the common lifecycle curve LC(A=aᵥᵢ).

TRᵥᵢ(t) is the time response function to explain calendar-time related factors that make the rate Rᵥᵢ(otᵥᵢ, t) deviate from the sole impact of aging. This function is vintage specific for now.

In E(1), rate R is modeled at the vintage level and is denoted as Rᵥᵢ(otᵥᵢ, t), indicating that the rate starts to have value at otᵥᵢ and changes with t. Rᵥᵢ(otᵥᵢ, t) is then factored into a base-rate function (lifecycle function), augmented by a level-shift factor βᵥᵢ, and further by the time-dependent time response function. The relationships among the three components are multiplicative.

The estimation of the components may be characterized as an iterated-stepwise process, which is commonly used in statistical procedural coding. The following sections elaborate the steps in the first iteration and then describes the looping process.

### Estimation of the Lifecycle Curve LC(A)

The lifecycle curve (function) may be estimated with sample data, and the complete sample may consist of all the vintage level curves. The estimation method of the lifecycle function depends on the underlying aging process of the subject rate. For instance, if the aging process can be theoretically specified with a certain functional form, then a parametric approach may be used, and the parameters may be established statistically. If there is no prior knowledge to establish a functional form, then each point in the curve may require individual estimation based on sample data at the same age-point.

The estimation below uses simple averaging to establish the lifecycle curve point-by-point, representing a non-parametric approach. Different weighting options (putting higher weights on more recent vintages, for example) may be incorporated into the framework.

For each point in the lifecycle curve, LC(A), the estimated value at A is calculated as the simple average of all sample values at point-in-age aᵥᵢ=A:

$$= \frac{1}{N ( a )} {\sum }_{i = 1}^{N ( a )} {r}_{vi} ( {ot}_{vi} , {a}_{vi} = ( A ) ) \qquad E ( 3 )$$

Where N(A) is the number of sample points at A, and as A gets larger, N(A) will get smaller.

If using LC(A) derived in E(3) to simulate Rᵥᵢ, the simulated curve (in-sample fit) will be exactly the common lifecycle curve. The next step is to model how an individual vintage would evolve differently from the average aging behavior.

### Estimation of the Calendar-Time Function

The difference between the actual curve Rᵥᵢ(otᵥᵢ, t) and the estimated lifecycle curve LC(A) can be expressed by the following ratio:

TRᵥᵢ(otᵥᵢ, t)=Rᵥᵢ(otᵥᵢ, t)/LC( [symbol] ) E(4)

TRᵥᵢ(t), therefore, measures the deviations of vi's actual behavior from the average aging pattern: if the ratio is 1 at certain point t, then the lifecycle behavior is not disturbed by time related factors; if the ratio is <1, then time related factors dragged Rᵥᵢ down to a point below its natural aging pattern; and if the ratio is >1, then time related factors pushed Rᵥᵢ up to a point above its natural aging pattern.

Further, TRᵥᵢ(t) may be directly modeled as a function of time-related factors. For example, regression models may be used to quantify level difference (the constant), events (dummy variables), seasonality and environmental factors like economy or operational policy changes.

The second stage model may therefore be specified as follows:

TRᵥᵢ(otᵥᵢ, t)=F(X1(t), X2(t), . . . , Xn(t))+ϵ(t), therefore:

TRᵥᵢ(otᵥᵢ, t)=F(X1(t), X2(t), . . . , Xn(t)) E(5)

Typical candidate variables for Xi(t) include three types:
Dummy variables indicating dips, spikes, gaps, level shifts, ramps and kinks;
Seasonal dummies indicating the 12 months in a year; and
Economic variables that can be expressed as a continued function oft, taking unemployment rate, for example.

Combining what has been derived from E(3), E(4) and E(5), the following equation results:

Rᵥₗ( [symbol] )=LC( [symbol] )*T [symbol] E(6)

In E(6), the actual Rᵥᵢ(otᵥᵢ, t) is explained with the common lifecycle function and the impacts of time related factors.

An alternative approach is to create a general time-response function TR(t) with pooled vintage-level time-response curves as follows:

$$= \frac{1}{N ( t )} {\sum }_{i = 1}^{N ( t )} {TR}_{vi} ( {ot}_{vi} , t ) = \frac{1}{N ( t )} {\sum }_{i = 1}^{N ( t )} [ {r}_{vi} ( {ot}_{vi} , t ) / ( LC ( ) ) ] \qquad E ( 7 )$$

When E(7) is used, then:

Rᵥₗ( [symbol] )=LC( [symbol] )* [symbol] E(8)

We will discuss how to best-fit Rᵥₗ( [symbol] ) with the common time-response function TR(t) with vintage-fitting parameters later on.

Curve Purification/Fine-Tuning through Iterations

Iterating a stepwise process is common in factor decomposition models. Once the time response function and vintage differentiating parameters are estimated, they may be factored out from the original (raw) sample using E(12).

[Rᵥᵢ(otᵥᵢ, t)]_{adj}=Rᵥᵢ(otᵥᵢ,t)/ [symbol] E(9)

Substitution of

[symbol]

Substituting the right-hand side of E(3) with E(9), the resulting estimation equation for the lifecycle function as E′(3) is:

$${E}^{′} ( 3 )$$

The iteration process will run through E(6) and will stop when the results are convergent.

### Full Simulation Model Formations

With E(8), the simulation is all based on the two collective behaviors, one on the age dimension and one on the calendar-time dimension. In order to accurately fit any individual vintage with these two common curves, the full simulation function may be written as follows:

Rᵥᵢ(otᵥᵢ,t)=βᵥᵢ*(LC(A=aᵥᵢ))^{α}*(TR(t))⁶⁵ ^{ᵥᵢ}*ϵᵥᵢ(t) E(10)

Where: LC(A) and TR(t) are to characterize common lifecycle and time response functions. The three vintage differentiating parameters (VDP) are established for the best vintage-level historical fit.
1. Parameter αᵥᵢ is introduced to adjust the curvature of LC(A) to better fit the shape of vintage-level curve, providing another dimension of freedom.
2. Parameter βᵥᵢ is the level-scalar for the vintage, accommodating level differences between the individual vintage curve and the lifecycle curve. This provides the second dimension of freedom.
3. Parameter γᵥᵢ is to individualize the relative sensitivity to the average time response function. This provides the third degree of freedom.

### Estimation of Vintage Differentiating Parameters (VDP)

The three vintage differentiating parameters are estimated with the following regression function for each segmented-vintage:

ln(r(otᵥᵢ,t))=ln(βᵥᵢ)+αᵥᵢ*ln(LC(A))+γᵥᵢ*TR(t)+ϵᵥᵢ(t) E(11)

Variations from the Full-specification

Four basic variations of E(13) are established to accommodate different lifecycle and time response patterns.

Variation 1—for processes that don't respond to calendar time factors

Rᵥᵢ(otᵥᵢ,t)=(LC(A))^{α}^{ᵥᵢ}*βᵥᵢ*ϵᵥᵢ(t) E(15)

Variation 2—for processes that don't respond to aging (flat-line lifecycle function)

Rᵥᵢ(otᵥᵢ,t)=βᵥᵢ*(TR(t))^{γ}^{ᵥᵢ}*ϵᵥᵢ(t) E(16)

Variation 3—for pointy lifecycle curves with an immaterial tail portion

Rᵥᵢ(otᵥᵢ,t)=(LC(A)^{α(v)}*β(otᵥᵢ=t)*ϵᵥᵢ(t) E (17)

Variation 4—for shape-migrating lifecycle curves

Rᵥᵢ(otᵥᵢ,t)=(LC(A))^{α(v)}*β′(otᵥᵢ=t)*ϵᵥᵢ(t) E (18)

Where β′ is formulated based on cumulative rate differences instead of level differences.

It should be noted that various changes and modifications to the presently preferred embodiments described herein will be apparent to those skilled in the art. Such changes and modifications may be made without departing from the spirit and scope of the present invention and without diminishing its attendant advantages.

We claim:

1. A lifecycle dynamic modeling system comprising:
a user device that includes a controller;
a database;
a memory within the wireless device and in communication with the controller, the memory including program instructions executable by the controller that, when executed by the controller, cause the controller to:
receive data from the database, wherein the data includes a plurality of data points over a period of time;
divide the data into a plurality of vintages based on time periods;
divide each of the vintages in a plurality of vintages into a plurality of segmented-vintage cohorts based on one or more attributes of the data; and
determine a score based on a modeling rate that varies over time, wherein the modeling rate is based on the plurality of segmented-vintage cohorts.

2. The lifecycle dynamic modeling system of claim 1, wherein the time periods are one-month periods. The lifecycle dynamic modeling system of claim 1, wherein the data includes historical data.

4. The lifecycle dynamic modeling system of claim 1, wherein the modeling rate comprises the following equations:
Rᵥₗ( [symbol] )=βᵥᵢ*(LC( [symbol] ))*TRᵥᵢ(t) E(1)
aᵥᵢ=t−otᵥᵢ E(2)
wherein Rᵥᵢ(oᵥᵢ,t) is the modeling rate, βᵥᵢ is a level-shift factor, LC(A=aᵥᵢ) is a value of a lifecycle function, aᵥᵢ is an age function, A is a specific age, TRᵥᵢ(t) is a time response function, t is a specific time, and otᵥᵢ is a month of one of origination and observation.

5. The lifecycle dynamic modeling system of claim 4, wherein the data includes historical data prior to the month of one of origination and observation.

6. The lifecycle dynamic modeling system of claim 4, wherein the lifecycle function comprises the following equation:
$$E ( 3 )$$
wherein N(A) is a number of sample points at A.
